(19) United States
(12) Patent Application Publication
(10) Pub. No.: US 2008/0147483 A1
(43) Pub. Date: Jun. 19, 2008

(54) METHOD AND SYSTEM FOR ONLINE COLLABORATIVE RANKING AND REVIEWING OF CLASSIFIED GOODS OR SERVICES

(76) Inventor: Jerry Jie JI, Citiport Centre (SG)

Correspondence Address: HUNTON & WILLIAMS/NEW YORK;INTELLECTUAL PROPERTY DEPT., 1900 K STREET, N.W., SUITE 1200, WASHINGTON, DC, 20006-1109, US

(21) Appl. No.: 11/952,562

(22) Filed: Dec. 7, 2007

(30) Foreign Application Priority Data
Dec. 14, 2006 (SG) PCT/SG2006/000389

(51) Int. Cl. G06Q 30/00; G06Q 10/00

(52) U.S. Cl. 705/10; 705/27

(57) ABSTRACT

A method to enable online collaboration to rank and review goods and services wherein, at a controller: all of the goods and services are classified according to a hierarchical structure of categories and sub-categories, each of the goods and services being able to be in more than one of the categories and sub-categories. Properties are allocated to the goods and services according to each of the categories and sub-categories. Rankings are received in accordance with defined criteria for each of the goods and services relative to others of the goods and services, the rankings being according to properties of the goods and services and the categories and sub-categories. Data is provided in relation to the rankings, the data being a number of rankings for each property of each of the goods and services in each of the categories and sub-categories according to the defined criteria. A corresponding apparatus is disclosed.

### TECHNICAL FIELD

The present invention relates to a method and system for online collaborative ranking and reviewing of classified goods and/or services and refers particularly, though not exclusively to information expansion and comparison through collaborative online ranking and review.

### BACKGROUND

Rational and value-conscious customers are in need of accurate and useful information to assist them in making informed decisions on which goods or services to purchase. Currently there are a few options open to them for use of online systems to attempt to obtain that information.

First are official web sites of vendors that provide authorized information on the goods or services of that vendor. However, not every goods or services provider has a web site. For example, not all restaurants have a web site. Secondly, even where the industry is by nature more web oriented such that every product or services provider has its own official web site, it is likely that the total number of such sites is so large for any reasonably developed region that to browse through each web site is prohibitively impractical. Third, browsing through various official web sites does not always help the potential customer make rational and informed decisions as it is difficult to know how well the supplier can provide its advertised goods and/or services. Finally, testimonials presented on the web sites normally give only the names of the allegedly satisfied customers and brief statements that may have been taken out of context. Also, there is no way of contacting those who have given the testimonies.

The second option is to use a search engine such as, for example, “GOOGLE”. However, there are still problems associated with their use. First, the information for the goods or services of interest to users is not hosted directly at the search sites. Instead, all that is provided is a list of links to other web sites that may provide the information required. To identify useful information from the sites listed by the search engine may take a considerable effort, and much time.

Secondly, the ranks associated with the links presented by search engines are computed with algorithms from a technical orientation that attempts to simulate the human view, but can never completely substitute for direct human opinions. Hence, direct feedback from other users will always remain invaluable in the selection of any goods or services.

Thirdly, search sites are generally designed to list links to the most relevant sites from a large number of possible sites. As such, they will be better for those who know for what they are searching. It is much easier to obtain from web search engines directions to information relating to a specific product or service than to a general question. For example, a request for information on the latest “Dell” “Inspiron” “9400 laptop” will provide many useful links whereas the question “Which small business laptop should I buy?” will generally give far less useful information as what is required is more general information—information relating to what makes and models of small business laptops are in the market and how they compare. Also, search engines by definition find resources on the Internet. Most sites are owned and maintained by business entities. As a result, the information found on the Internet still represents the opinions of business entities, rather than direct opinions from consumers.

The third option is to use online forums devoted to specific topics. This would include web-based question and answer sites. However, the useful information, if it exists, is usually buried at random at various places in a very large number of comments. Those comments will be of varying of relevance and accuracy. As such, use of such online forums is extremely time consuming and labor intensive.

A number of web sites offer various forms of user rating and/or user-to-user recommendation functions. For example, “AMAZON”, a web site for online purchasing, attempts to collect user ratings for almost every product it lists. Given a user selection of a particular product, it also presents a list of other products based on mapping from other users' preferences collected online. Each product listed would be given an aggregated rating from the ratings given by previous purchasers, and a digest of comments from previous purchasers.

However, ratings collected online often don't suit the intending purchaser due to differences in taste and need. Also, it's almost impossible to keep rating standards consistent, homogeneous and rigorous. For example, a person who is new to a field such as, for example, web design, may purchase and read a on the subject. Due to their inexperience and as the book answers their immediate questions, they think it is great and give it a rating of 5 out of 5. Three weeks later, the same person, who has been steadily adding to their knowledge of and experience in web design, purchases and reads another book on web design. They believe it is very good and give it a rating of 4.5 out of 5. However, when asked to compare them, they recommend the second book. Unfortunately, the ratings on the web site may completely misdirect other potential purchasers.

As another example, a professor may read two books on the same topic. They believe both are excellent compared with other books in the market and on the same topic. They give both a rating of 5 out of 5 because giving either one a different rating would be unfair. They are subsequently approached by a student who can afford to buy only one of the books. The professor recommends one over the other as it would be slightly better for the student than the other. Unfortunately, this information is not captured in the ratings left on the web site.

As yet another example, a new MP3 player is released. It is given a rating of 5 out of 5. Approximately 6 months later a newer model MP3 player with improved functions and performance is released and is also given a rating of 5 out of 5. Both ratings accurately reflect the true status of both products at the time they were released. However, by comparing the ratings on the two products, a potential purchaser cannot differentiate them. Ratings date and most ratings remain with a product as long as the product remains on the market, despite changing circumstances.

Also, ratings given with consistent standards of accuracy can be difficult to interpret, and depend greatly on the abilities of the person providing the rating. For example, which book should one choose when one has an average rating of 5 out of 5 from the general public, or the book that has a rating of 4.5 out of 5 from 27 experts?

A number of web sites exist that provide price-comparison services for specific goods and service, such as http://www.pricegrabber.com and http://www.travelocity.com. However, they compare prices only, and do not rank the products or services as such.

### SUMMARY

According to an exemplary aspect there is provided apparatus to enable online collaborative to rank and review goods and services. The apparatus comprises a web server to provide an interface between machines of users and a controller. The controller is configured to: send data to and receive data from the web server, deposit data to a plurality of databases, retrieve data from the plurality of databases, and to process data to and from the plurality of databases. The plurality of databases comprises a goods and services database to list goods and services according to a plurality of categories, a goods and services rankings database to list rankings of goods and services according to a plurality of properties, a goods and services discussion database to store user comments on the goods and services and ratings on other users' comments, and a user profile database to store user identities, user reputation values and user popularity values.

At least one of the plurality of categories may comprise at least one sub-category. The plurality of categories may be in a hierarchical structure of classifications.

The goods and services database may be to store all information of goods and services including the names of the goods and services, an alias for the goods and services, a simple description for the goods and services, a date from which each of the goods and services has been available, a geographical area of availability of each of the goods and services, and a listing of categories of classifications within which the goods and services are placed.

According to another exemplary aspect there is provided a method to enable online collaboration to rank and review goods and services. The method comprises, at a controller: classifying all of the goods and services according to a hierarchical structure of categories and sub-categories, each of the goods and services being able to be in more than one of the categories and sub-categories; allocating properties to the goods and services according to each of the categories and sub-categories; receiving rankings in accordance with defined criteria for each of the goods and services relative to others of the goods and services, the rankings being according to properties of the goods and services and the categories and sub-categories; providing data in relation to the rankings, the data being a number of rankings for each property of each of the goods and services in each of the categories and sub-categories according to the defined criteria.

The method may further comprise providing an indicator of subjectivity and objectivity for each of the properties; and the controller receiving and entering proposals selected from: new goods, new services, new property for selected goods and services in a category, additional classifications for a particular product or service, to remove a classification for a particular product or service, to migrate a classification of a product or service, and to change a classification of selected goods or services.

The controller may post the proposal on a web site for approval and adopt and enter the proposal when a predetermined number of endorsements of the proposal are received. The predetermined number may vary according to the category and category level. The ranking of at least one of the goods and services may differ according to the categories and sub-categories.

The properties of goods and services in a category may be generic to all goods and services in that category, including all sub-categories of the category. The controller may suppress a property of a category in a sub-category when that property is not relevant for the sub-category.

The method may further comprise the controller receiving and entering objections to a ranking, wherein the ranking is deprecated or discarded, or a classification changed, if a sufficient number of objections are received; and the controller receiving comments according to at least one of: the categories and sub-categories; the comments being at least one selected from: on the goods and services, and on previous comments. The controller may assess the comments according to a reputation value of a user who provided the comments. The reputation value may be determined by ratings on comments of a user, and time decays for different categories of goods and services.

The controller may display competing goods and services on a web site controlled by the controller, the display containing basic information on the competing goods and services, and a ranking matrix on each of the properties for the category or sub-category of the competing goods and services.

Goods and services in a sub-category may inherit properties from their parent category. The controller may provide a weighting to at least one of the properties. At least one of the sub-categories may comprise at least one sub-sub-category. The controller may save a ranking relationship between goods and services in a goods and services ranking database. The controller may save comments received in a goods and services discussion database. The controller may differentiate between rankings received from registered machines, and rankings received from unregistered machines.

Rankings may be according to at least one of: much better than, better than, similar to, worse than, and much worse than. The indicator of subjectivity and objectivity may be amended by the controller on instructions received from a registered machine. The indicator of subjectivity and objectivity may be a filter criterion.

The reputation value may be different for different categories and sub-categories. The reputation value may be determined by the controller from ratings received for the comments received from a machine under a category.

Rankings may be according to a numerical scale. Rankings may be modified with a “much” modifier. The controller may display comments for an initial period to collect ratings on the comments and, after the initial period, the controller may determine a configurable value for each machine and use the configurable value to determine which comments should be displayed on a web site controlled by the controller. The initial period may depend on one or more of: the category or sub-category of the goods and services, whether the comment is from a registered machine or an unregistered machine, and the reputation value.

The configurable value may be determined by the controller to compare with the average rating of the comments. The controller may fold all postings where the average rating is below a configurable threshold without displaying the comments on the web site. The controller may display on the web site a distribution of ratings of the folded comments. The controller may display on the web site a configurable percentile of the top rated comments. The controller may post comments without identifying the user who provided the comment when so instructed by the user's machine.

According to a further exemplary aspect there is provided a method to collaborate online to rank and review goods or services, the method comprising: a machine sending to a controller rankings in accordance with defined criteria for each of the goods and services relative to others of the goods and services, the rankings being according to properties of the goods and services and categories and sub-categories of the goods and services; and the machine sending to the controller comments on the goods and services.

An indicator of subjectivity and objectivity for each of the properties may be amended. The machine may send to the controller proposals selected from: new goods, new services, new property for selected goods and services in a category, additional classifications for a particular product or service, to remove a classification for a particular product or service, to migrate a classification of a product or service, and to change a classification of selected goods or services.

The ranking of at least one of the goods and services may differ according to the categories and sub-categories. The machine may send objections to a ranking to the controller; comments according to at least one of: the categories and sub-categories; the comments being at least one of: on the goods and services, and on previous comments.

Rankings may be according to at least one of: much better than, better than, similar to, worse than, and much worse than. Alternatively rankings may be according to a numerical scale. Rankings may be modified with a “much” modifier.

The machine may send to the controller instructions to post a comment without identifying the user who provided the comment.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 is a block diagram illustrating the structure of a web site that implements an exemplary embodiment and illustrates the flow of data between components;

FIG. 2 is a block diagram illustrating the structure of one embodiment of the exemplary embodiment of FIG. 1;

FIG. 3 is a flowchart illustrating the process steps of a method for providing online ranking of goods and service according to the exemplary embodiment;

FIG. 4 is an illustrating of one possible representation of the ranking on a product;

FIGS. 5.1 to 5.3 illustrate one representation of the ranking results of the product of FIG. 4 and other similar products;

FIGS. 6.1 to 6.3 illustrate one representation of the ranking results on the property level of the products of FIG. 4;

FIG. 7 illustrates the ranking process under fine grained control; and

FIG. 8 illustrates the evolution of the reputation values of categories for a registered user.

### DETAILED DESCRIPTION OF THE EXEMPLARY EMBODIMENTS

In the drawings, the same reference numerals are used to indicate the same elements.

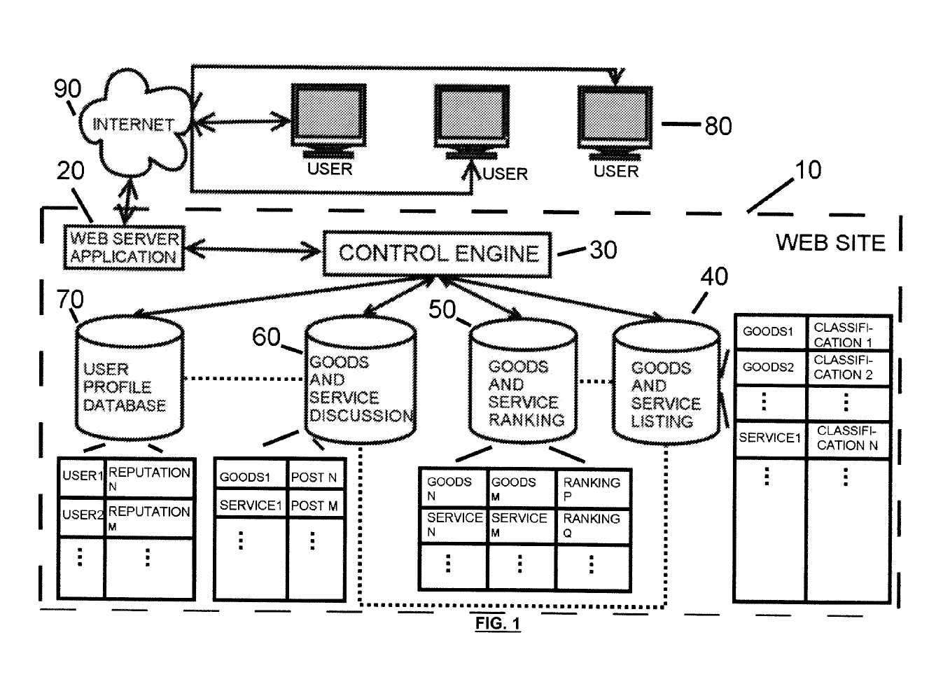

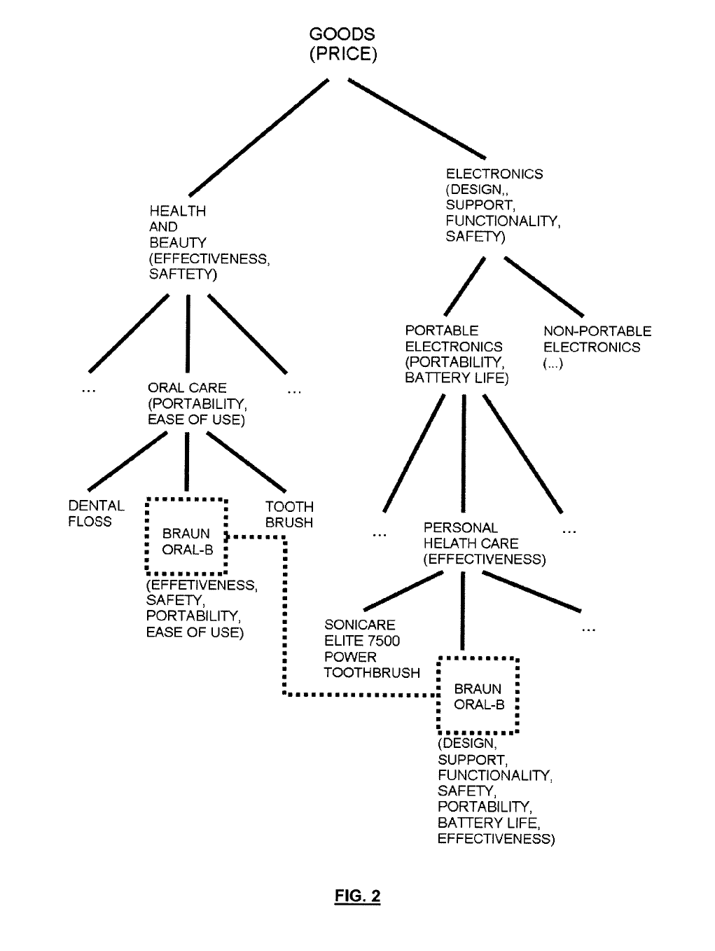

FIG. 1 is a block diagram illustrating a web site that operates in accordance with the exemplary embodiment, and illustrates the relationship between the various components. The system 10 represents the entire web site, which can be implemented by a web server 20 and a number of databases 40, 50, 60, 70 that can be accessed by machines 80 of users through the Internet 90.

The web server 20 is an interface that uses an application to transmit downloaded data to the machines 80 when received from a controller 30, and receives uploaded data from the machines 80 and sends it to the controller 30.

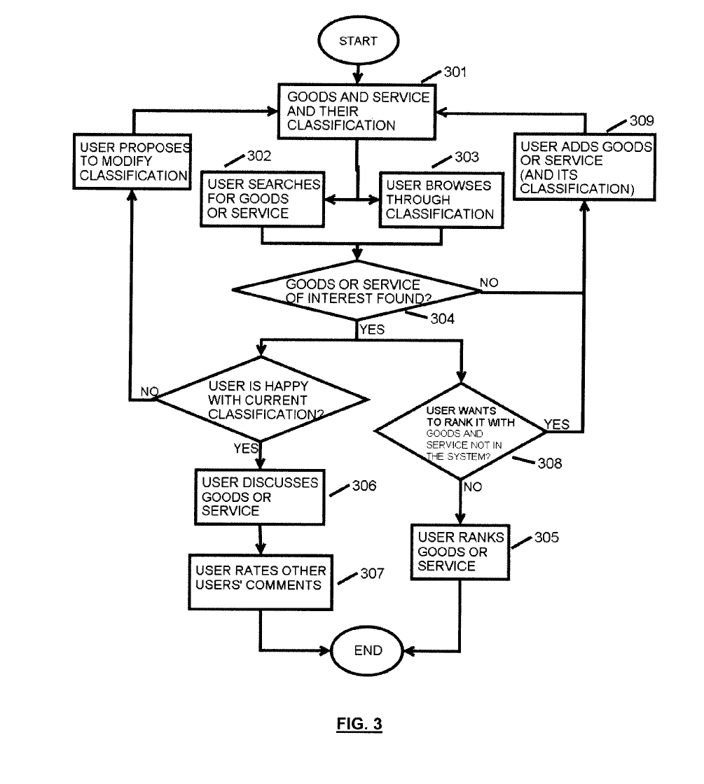

The controller 30 is the central control system that performs the method described below in relation to FIG. 2. The controller 30 sends data to and receives data from the web server 20; deposits data to the databases 40, 50, 60, 70; retrieves data from the databases 40, 50, 60, 70; and processes data to and from the databases 40, 50, 60, 70.

The goods and service listing database 40 stores all the information of goods and services, such as their name, alias, simple description, the date from which it has been available, geographical area of availability, an hierarchical structure of classifications, and a listing of categories of classifications within which the goods and services are placed. Hence, when data is received from machines 80 to:
propose new goods or services;
propose additional classifications for a particular product or service;
propose to remove a classification for a particular product or service; or
propose to migrate or change a classification of a particular product or service the information in goods and service listings database 40 is updated accordingly.

The proposals may be one or more of: text input boxes, file and/or image upload, and submission buttons in a web page for online submission. Goods and services are classified under multi-dimensional categories. This means that all goods and service can reside under multiple categories to ease access from the classification directory, and to enrich the breadth of the ranking process. For example, a “Braun” “Oral-B” electric tooth brush may be classified under: goods>“health and beauty”>“oral care”, and goods>“electronic”>“portable electronics”>“health care electronics”. In this way it can be ranked both with other dental care products such as conventional toothbrushes and dental floss, as well as with other electric toothbrushes.

The goods and service ranking database 50 stores all data relating to the ranking information of all goods and services.

The goods and service discussion database 60 stores all data relating to comments on goods and services and the ratings posted for them.

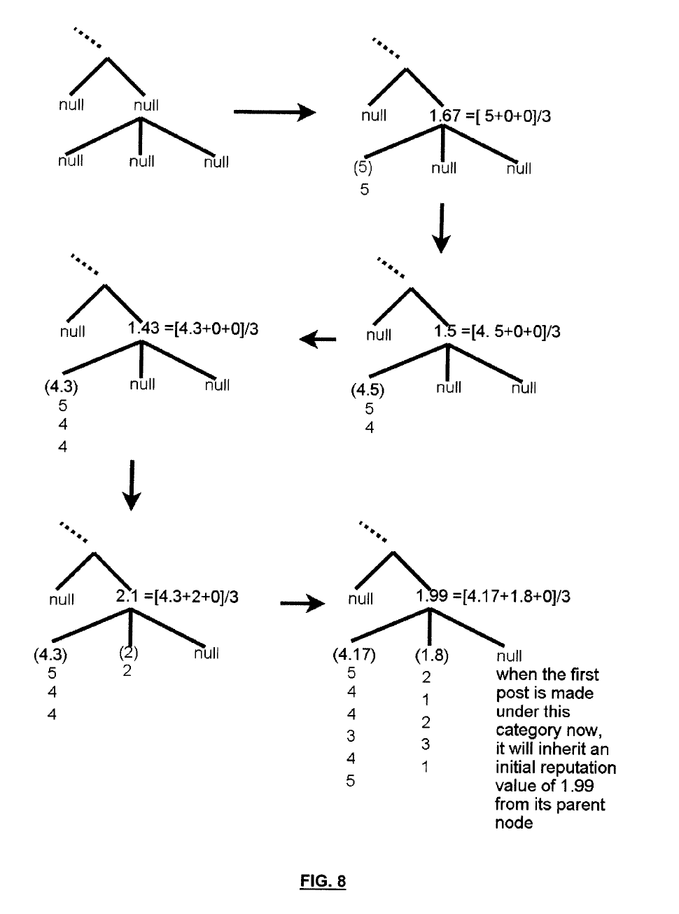

The user profile database 70 stores all data relating to registered users such as, for example, user ID, user reputation, and user popularity values, which will be described in greater detail below in relation to FIG. 8.

In FIG. 2, the tree branch nodes are the hierarchies of the various categories and their sub-categories. There may be sub-sub-categories, if required or desired, and further division into even more sub-sub-sub-categories. For convenience, the following description refers to categories and sub-categories only. That is to be taken as including references to various levels of sub-categories.

The tree leaf nodes are the hierarchies of the various goods and services in each category or sub-category. Each category may have many sub-categories, or as few as one or none. Each category or sub-category may have many leaf nodes (goods and services), or as few as one. Considering the above example of the “Braun” “Oral-B” electric tooth brush, it appears in two leaf nodes and thus each of those two leaf nodes represent the same product classified under two different categories. The same product can be ranked separately in each category as in each category it can be ranked with different competing products according to the properties applicable in that category or sub-category. The properties in parenthesis beside each category or sub-category node represent the properties common to that level of category. Therefore, properties in parenthesis for the two leaf nodes of the “Braun” “Oral-B” electric tooth brush are the properties that can be ranked according to their respective classification paths.

The words in parenthesis besides the branch nodes are the properties associated with the respective level of categories. Each level of category may have properties that are preferably generic to all goods and services in that category, and its subcategories. For example, all goods and services will have a price property, while “food and drink” under the goods category will have a property of taste. Similarly, “vehicles” under the goods category will have the property of durability. The properties applied to each category or sub-category of goods and services will be those relevant for the goods and services in that level of category. Again, using the “Braun” “Oral-B” electric tooth brush example, the property of “battery life” is applicable in the “Portable Electronics” category, but not the Health and Beauty category.

The ranking relationship between the goods and services is saved in the goods and services ranking database 50. The ranking is between the properties of the competing goods and service within a category or sub-category. For example, the ranking between two models of the compact digital cameras “Fuji” “FinePix F30” and “Canon” “IXUS 65”, both under goods>electronics>“portable electronics”>“digital camera”>“compact digital camera”, will be under, but are not limited to, the properties:
“price” as inherited from the top-most goods category,
“design” and “functionality” and “support” as inherited from the electronics category,
“portability” and “battery life” as inherited from the portable electronics category, and
“image quality”, “speed”, “software” and “zoom range” from the digital camera category.

Settings specific to a sub-category may be used to suppress the application of properties from the parent category that are not truly relevant to the sub-category. For example, the digital camera sub-category may suppress the property “safety” inherited from its ancestor category “electronics”.

New properties may be added from each machine 80. For example, for compact digital cameras an additional property of “anti-shake” may be proposed by an online feedback submission process received at the controller 30. The proposal may be similar to the online feedback method previously described. The proposal may be verified by an automatic process. In that process the controller 30 will post the new property on the web page for approval when a predetermined number of endorsements are received at the controller 30. The predetermined number may be preset and may vary according to category and category level. The endorsement process can take the form of selection and submit button on web page similar to the proposal process. Once a property proposal is approved, it will be added to the existing property list for use in rankings.

Similarly, objections may be raised to a ranking. For example, although a “Toyota Camry CE” and “BMW 3 Series” can both be found under goods>vehicle>car>sedan, the ranking between them may be deprecated or discarded and one of them moved to a new category if there are a sufficient number of objections raised. The sufficient number may be preset and may vary according to category and category level. The objections are received by controller 30 from machines 80. The new category may be a pre-existing category or may be a newly-created category. The goods and services ranking database 50 stores the ranking relationship between the attributes of the goods and services according to votes received from machines 80.

The goods and service discussion database 60 stores online comments received from machines 80 by the controller 30. Comments are for goods and services of interest under one of the categories or sub-categories. The initial visibility factor of each of the comments is determined by the reputation value of the user that stored in the user database 70. The reputation value of each user will evolve over time depending on factors including, but not limited to, ratings on the comments of a user as received by controller 30 from other users via their machines 80, and different time decays for different categories of goods or services that have different sensitivity to time. The detailed relationship between the reputation values and the discussion/comment rating process are described below in greater detail in relation to FIG. 8.

FIG. 3 is a flow chart illustrating an exemplary process flow. When a machine 80 accesses the web site, they are given two methods to access the information associated with the goods and services (301). First, if they have a clearer idea of the goods or service they are looking for, they can search the database 40 using keywords (302). Alternatively, a search may be made for the group or groups of goods or services using keywords (303) or browse through the classified categories. If the search of the goods and services database 40 reveals an existing entry (304), basic information on the goods or services and a list of similar and/or competing goods and services in the same category and level, and the sorted ranks the controller 30 received from machines 80, are supplied. Rankings may be separated into those from machines 80 of registered users, and those from machines 80 sent to controller 30 anonymously.

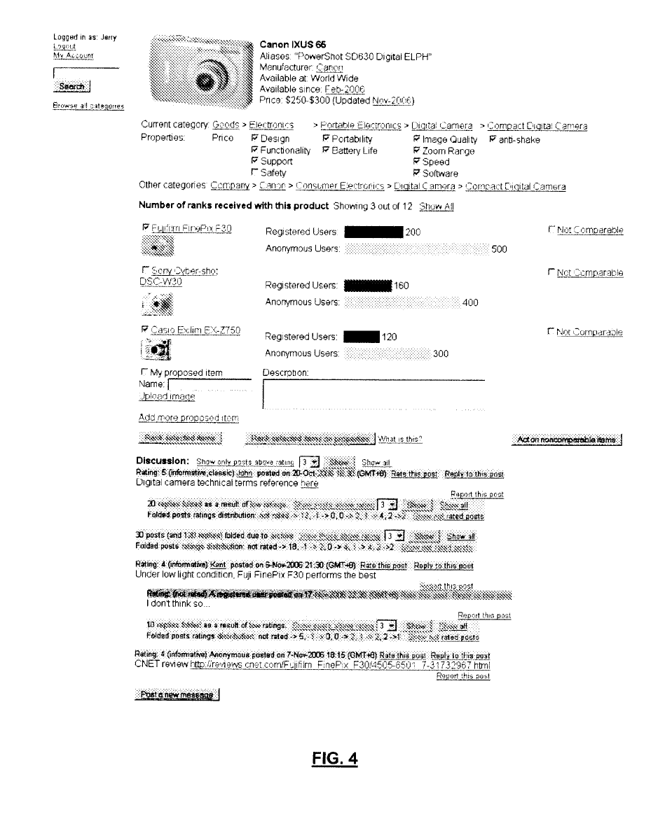

One or more products or services from the list may be selected to view the ranking details or to rank them. If it is desired to view the ranking details on the database 50, upon the relevant selection being made the controller 30 obtains the data from the database 50 and downloads it to the machine 80 via server 20. The data will contain detailed ranking results of the selected products. This process is described in greater detail below in relation to FIG. 4.

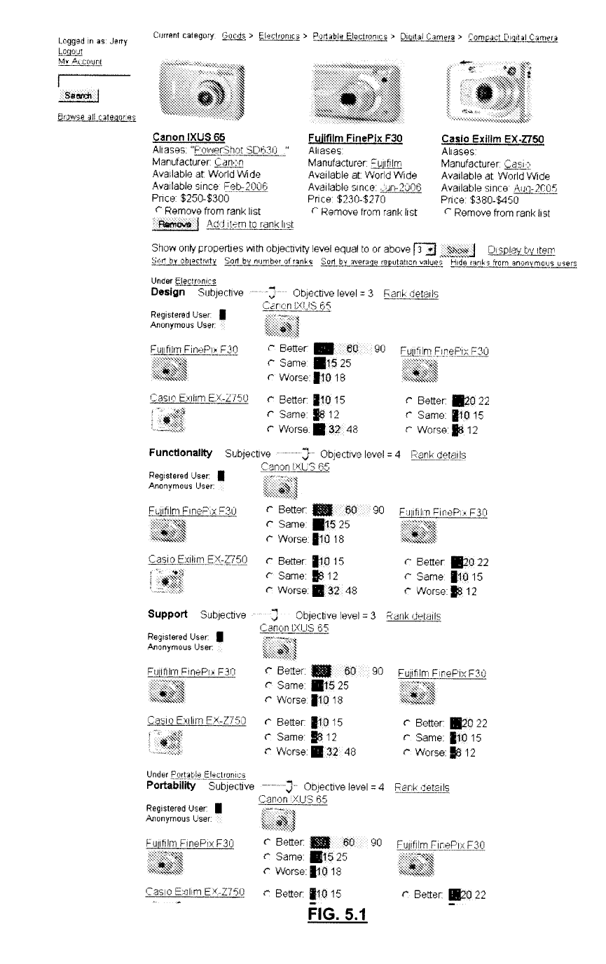

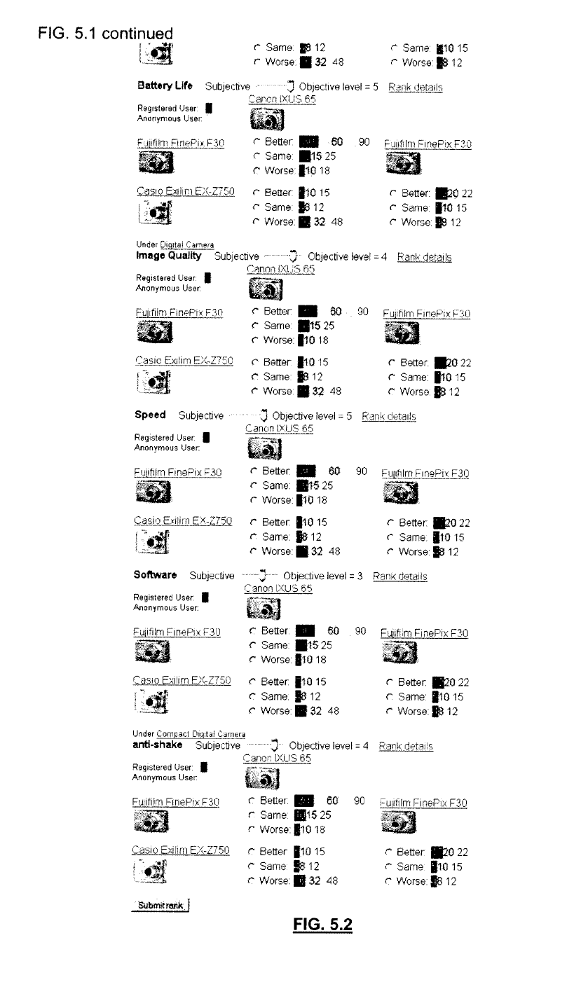

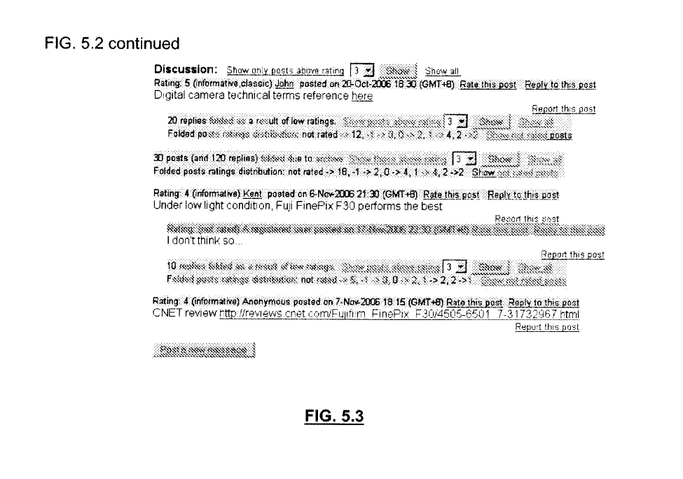

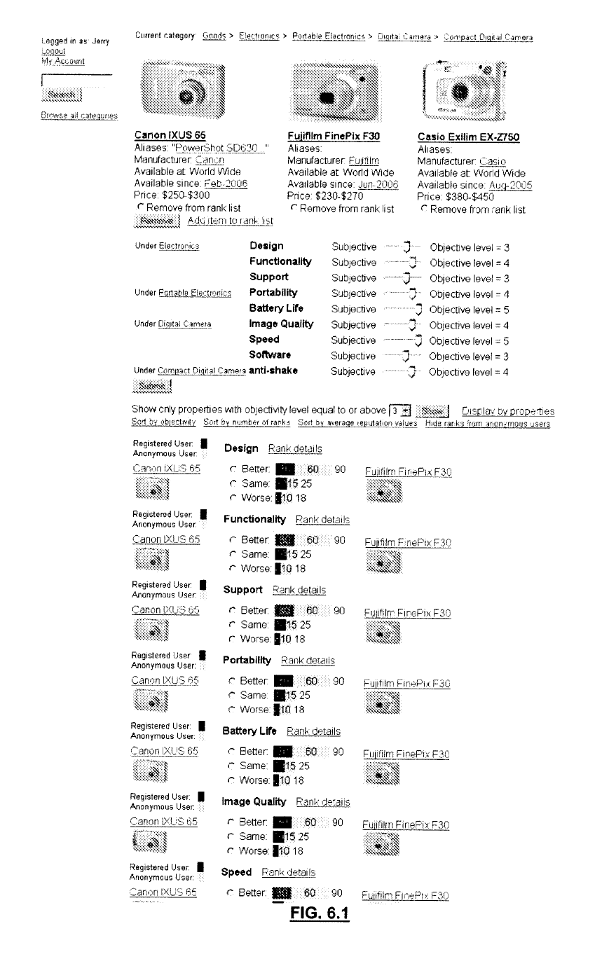

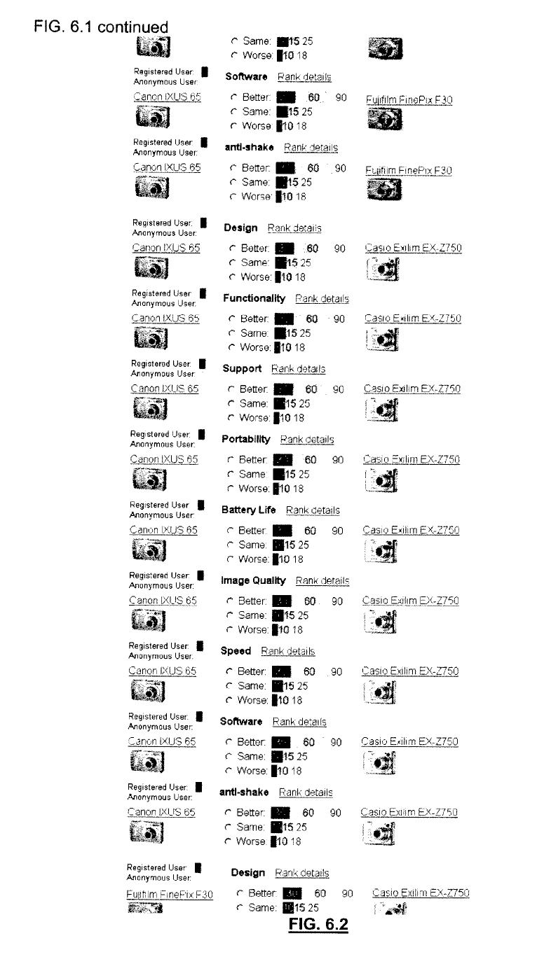

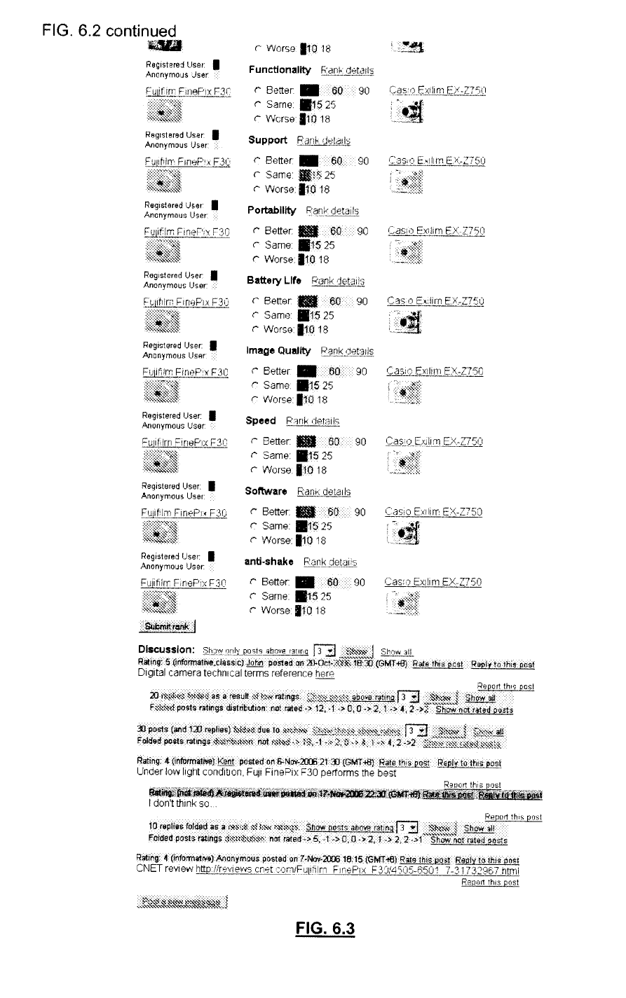

When ranking the goods or services (305), upon selecting one or more items from the list they can be sorted in a chain with comparative relationships including, but not limited to:
“better/higher than”,
“much better/higher than”,
“similar to”,
“worse/lower than”,
“much worse/lower than
   under one or more selected properties associated with the goods or services. The ranking process is covered in greater detail in relation to FIGS. 5 and 6. If ranking relative to goods and services that are not listed is required (308) the relevant goods and services can be added (309) as is described above. If at (304) the goods or services are not in the database 40, they can be added (309) as is described above. Comments may be provided to the controller 30 for adding to the database 60 (306) and for ranking other comments to impact the reputation value as stored in database 70 (307).

FIG. 4 is a web page screen capture illustrating one preferred presentation of such a ranking on the product level. The product, a “Canon” “IXUS 65” digital camera is presented on the top of the web page, followed by a listing of competing products in the same category sorted by the number of ranks received when compared with the Canon IXUS 65. The rank is further divided into those from registered users, whose ranking votes can be tracked, and those from anonymous users, whose ranking votes can not be tracked. One or more competing goods or services can be selected from the list and their ranking details viewed. New competing goods or services can be proposed if they do not exist in database 40 by uploading to controller 30 the relevant information for the new goods or services. As shown, two existing cameras have been from the list—a “Fujifilm” “FinePix F30” and a “Casio” “Exilim EX-Z750”. The details and ranking details can be viewed, and/or rankings of them, may be done by clicking on the “Rank selected items” button. This is covered in greater detail in relation to FIGS. 5 and 6. Sorted user discussions are presented towards the bottom of the page. The user discussion process is illustrated in greater details in relation to FIG. 8.

FIG. 5 (comprising FIGS. 5.1, 5.2 and 5.3) is a web page screen capture illustrating one representation of the ranking details for a user who has clicked on the “Rank selected items” button after selecting one or more competing products from the web page in FIG. 4.

On the top of the page, the three competing products are listed with their basic information, followed by a ranking matrix on each of the properties inherited by and associated with their lowest category level—design, functionality, support, portability, battery life, image quality, speed, software, and anti-shake.

Each property may have an indicator for subjectivity/objectivity. Each property that is non-objective would have a subjectivity-objectivity indicator associated with it indicating the subjectivity (objectivity) level of the property. The subjectivity (objectivity) level may be amended by any registered user accessing the data. The subjectivity (objectivity) level can be used to filter criteria for users who, for example, ask the system to show them only ranking details on those properties that are at least 80% objective. The subjectivity (objectivity) level of a property that exhibits a strong degree of inclination can be locked down by the controller 30. An example of this is the 0-100 mph acceleration time for a car as it is purely objective. However, one that is relatively subjective is design.

A preferred presentation of the ranking details as shown in FIG. 5 is to sort the ranking into a quasi table that provides the data comparing two items. As shown this is by “better”, “same” and “worse”. The length of the indicator bars corresponds to the number of ranks received. The rankings from anonymous users and registered users are distinguished by different colors or tones. Further, other indications such as, for example, a gradual changing of the color, or a 3-D effect, of the indicator bar can be used to signify more rankings received from “expert users”. Expert users are those who are registered users and who have received higher ratings with their comments. This means they will have a have higher reputation value for goods or services in the relevant category and level.

Selected items as well as proposed items can be ranked by selecting the relevant button and clicking on the “submit” button found below the ranking details listing. For example, when ranking four different models of compact digital camera under the “anti-shake” property, one may be selected as being “better than” another. Selection may have a checking mechanism to safeguard the correctness of the entries and to prevent circular ranking relationships (i.e. each is better than the others) from occurring. The ranking may be repeated for each of the properties desires to be ranked. As shown, this is the default pre-selected properties inherited from parental categories except for the “safety” property as this is masked-out by the controller 30 for the digital camera category.

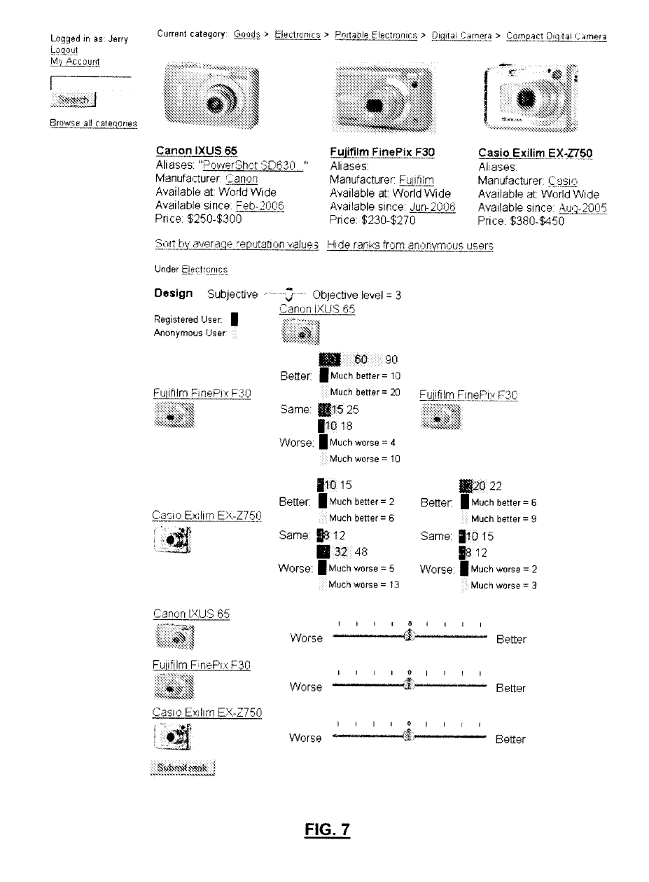

Some or all of the properties may be weighted. The controller 30 will perform all necessary calculations. As a result, one or more numbers for each of the goods or services selected will be presented for comparison. An average reputation is defined as the geometric average of the reputation values under the relevant category of all users who voted a rank. A user's reputation value may be different for different categories and sub-categories of goods and services. Calculation methods for the numbers for comparison may include, but are not limited to:
the sum of the average reputation of each property,
the sum of the products of the user's given weight with the corresponding property's average reputation value,
the sum of the products of the users given weight with the corresponding property's average reputation value and the objectivity level, or
any of the above divided by the median or mean price of the goods or services.
   The numbers are intended to serve as a simple one-glance indicator to further ease users in their decision making. As shown on FIG. 5.3, at the bottom of the web page, rated user discussions on related products under this category are presented. The ranking presentation and the user discussion and rating process will be described in detail in relation to FIG. 7.

FIG. 6 is a web page screen capture illustrating one presentation of the ranking details on the property level. It is a different presentation of the same underlying ranking relationships used in FIG. 5 and is accessible from clicking the “Rank selected items on properties” button in FIG. 4 or the “Display by item” link in FIG. 5.

FIG. 7 is a web page screen capture illustrating one presentation of the ranking details on a property. It shows a further breakdown of the ranking between the selected products in greater details under the “Design” property. In this way it is possible to view the number of the rankings with a “much” modifier. It is also possible to rank the goods or services with the “much” relationship by dragging the sliders at the bottom of the page. The further the slider is to the right, the better the property of the good and services. A difference of one step between the positions of different products means a “better” relationship, while a difference of two or more steps between positions of different products represents a “much” relationship.

FIG. 8 is a flow chart illustrating the evolution of a registered user's reputation value for a small sub-tree of the leaf-end categories. To avoid anarchism and to raise service quality, all users, registered or not, are allowed to rank goods and service and post comments. However, only selected registered users are allowed to rate other users' postings. The selection may be random. Rankings can be done on a numerical scale of, for example, −1 to 5 on two main criteria:
the criteria for content, such as informative level, and
the criteria for presentation, such as entertainment level.

Multiple ratings of different values may be given to a posting at the same time. For example, a posting may be rated 5 on the basis that it is informative, yet be rated 3 on the basis of its humour.

Whether or not a non-new, defined later, comment is able to be viewed is determined by controller 30 on the basis of the aggregated ratings. To viewers of the web page with default settings, the system will display only postings with ratings at least as high as a configurable value, e.g., 3, in content as well as presentation. All postings with ratings below the threshold will be folded by the controller 30 without displaying the content. Alternatively the controller 30 may display a configurable percentile of the top-most rated postings such as, for example, the top-most 30% ratings. When a group of postings is folded by the controller 30, the distribution of the ratings of the folded postings may be shown on the web site. For example, when ten postings are folded because their ratings do not meet the configured threshold, either a hard figure of 4 or a small percentile, the controller displays on the web site that among the ten postings there is one posting of rating −1, five postings of rating 0, three postings of rating 1, and two postings of rating 3. Controller 30 may perform archive folding on user comments under high volume categories to fold all comments older than a certain threshold time irregardless of their ratings. Controller 30 may also make “classic” any and all postings that have received more than a configurable threshold of ratings such that they are immune to the archive folding mechanism.

Viewers of the web page may have control over the extent of the postings to be shown by changing the threshold value. When a new posting is made, it is given an initial period in which it is able to be displayed in order to collect rankings. After that initial period the posting is no longer considered new and the decision to display or delete it will be by the controller 30 using the user configurable value. The initial period may depend of the category of the goods or services concerned, and is for collecting ratings for the new posting. The initial period will be shorter for postings made by anonymous users than for postings made by registered users. It may also be configured to be related to the volume of the postings under the category in which the posting is made and/or the number of times the posting is viewed. For example, the initial period of visibility of a posting made for a newly released computer game under an Internet game category where it is read every second and new postings are made every minute, will be given a much shorter initial period of, for example, an hour, than the initial period for a posting made in a low read/posting volume category of, for example, Books>Politics>“Political Study for South East Asia”. In the latter case a new posting needs to be given an initial period of many days for it to be viewed at a comparable number of times as that of the computer game.

When the initial period expires, the controller 30 will determine whether to display on the web site controlled by the controller the posting based on the average rating it received, and the user's threshold setting. The initial period for registered users is also related to the reputation values the user has accumulated under the category concerned. The reputation values of a category are the average ratings in content the user receives for comments posted in that category. The reputation value in a child category contributes to the reputation value in its immediate parent category.

As illustrated in FIG. 8, the numbers at the branch and leaves of the category trees represent the evolution of the reputation values associated with a particular registered user. Initially, all reputation values are null. When the user posts a comment in a leaf category and that comment receives ratings, the reputation value associated with that category, in parenthesis, is the arithmetic average of the ratings. The reputation of the immediate parent category is also updated according to the average of the reputation values from all its immediate children nodes, where a null value is regarded as zero. When that user posts a comment in another leaf category in which they have not previously posted a comment, the initial period received will be determined from the then reputation value in the parent category. As such the reputation value is inherited from the reputation value of the immediate parent category.

All reputation values will also be subjected to time decay at different rates according to different categories. For example, reputations associated with electronics or computer software categories will have a much higher time decay factor (i.e. will decay faster) than that of the food and drink category. This means that reputation values associated with the electronics category will be reduced by the controller 30 at a much faster rate than for those in the food and drink category.

Popularity may be rated on the presentation criteria and may not exhibit similar category centric properties. Therefore, it is associated with a particular user and is not relevant to the category within which the ratings are received. Also, popularity will be subjected to a weaker time decay factor compared with that for reputation values. Hence, the reputation and popularity values of a registered user (and the corresponding category, for reputation) will evolve over the time under the forces of rating and time decay.

Any user may file report against postings that are considered extremely offensive. When the controller 30 receives more than a predetermined number of reports filed against a posting, it will suppress the posting so it cannot be viewed and attention will be drawn that may lead to the posting being deleted from database 60. In extreme cases, if such a posting were by a registered user, the user may be subjected to appropriate disciplinary action including, but not limited to, downgrading of their reputation and/or popularity values, and suspension or revocation of their user ID. Finally, a user wanting to preserve their privacy can instruct the controller to not reveal their user ID when posting their comment.

The present invention provides a method and system for providing improved collaborative online information exchange and digest to help users of the web site in making informed purchase decisions, which overcomes the problems associated with conventional systems and methods current online information providers employ.

Whilst there has been described in the foregoing description preferred embodiments of the present invention, it will be understood by those skilled in the technology concerned that many variations in details of design, construction and/or operation may be made without departing from the present invention.

1. Apparatus to enable online collaborative to rank and review goods and services, the apparatus comprising:
a web server to provide an interface between machines of users and a controller;
the controller being configured to: send data to and receive data from the web server, deposit data to a plurality of databases, retrieve data from the plurality of databases, and to process data to and from the plurality of databases;
the plurality of databases comprising:
a goods and services database to list goods and services according to a plurality of categories,
a goods and services rankings database to list rankings of goods and services relative to others of the goods and services according to a plurality of properties,
a goods and services discussion database to store user comments on the goods and services and ratings on other users' comments, and
a user profile database to store user identities, user reputation values and user popularity values.

2. Apparatus as claimed in claim 1, wherein at least one of the plurality of categories comprises at least one sub-category; and the plurality of categories is in a hierarchical structure of classifications.

3. Apparatus as claimed in claim 1, wherein the goods and services database is to store all information of goods and services including the names of the goods and services, an alias for the goods and services, a simple description for the goods and services, a date from which each of the goods and services has been available, a geographical area of availability of each of the goods and services, and a listing of categories of classifications within which the goods and services are placed.

4. A method to collaborative online to rank and review goods or services, the method comprising, at a controller:
classifying all of the goods and services according to a hierarchical structure of categories and sub-categories, each of the goods and services being able to be in more than one of the categories and sub-categories;
allocating properties to the goods and services according to each of the categories and sub-categories;
receiving rankings in accordance with defined criteria for each of the goods and services relative to others of the goods and services, the rankings being according to properties of the goods and services and the categories and sub-categories;
providing data in relation to the rankings, the data being a number of rankings for each property of each of the goods and services in each of the categories and sub-categories according to the defined criteria.

5. A method as claimed in claim 4 further comprising the controller providing an indicator of subjectivity and objectivity for each of the properties.

6. A method as claimed in claim 4 further comprising the controller receiving and entering proposals selected from the group consisting of: new goods, new services, new property for selected goods and services in a category, additional classifications for a particular product or service, to remove a classification for a particular product or service, to migrate a classification of a product or service, and to change a classification of selected goods or services.

7. A method as claimed in claim 6, wherein the controller posts the proposal on a web site for approval and adopts and enters the proposal when a predetermined number of endorsements of the proposal are received, the predetermined number varying according to the category and category level.

8. A method as claimed in claim 4, wherein the ranking of at least one of the goods and services differs according to the categories and sub-categories.

9. A method as claimed in claim 8, wherein the controller suppresses one or more properties of a category in a sub-category when that property is not relevant for the sub-category.

10. A method as claimed in claim 4 further comprising the controller receiving and entering objections to a ranking, wherein the ranking is deprecated or discarded, or a classification changed, if a sufficient number of objections are received.

11. A method as claimed in claim 4 further comprising the controller receiving comments according to at least one of: the categories and sub-categories; the comments being at least one selected from the group consisting of: on the goods and services, and on previous comments.

12. A method as claimed in claim 11, wherein the controller assesses the comments according to a reputation value of a user who provided the comments, the reputation value being determined by the controller by ratings on comments of a user, and time decays for different categories of goods and services.

13. A method as claimed in claim 4, wherein goods and services in a sub-category inherit properties from their parent category and at least one of the sub-categories comprises at least one sub-sub-category.

14. A method as claimed in claim 4, wherein the controller differentiates between rankings received from registered machines, and rankings received from unregistered machines.

15. A method as claimed in claim 6, wherein the indicator of subjectivity and objectivity is amended by the controller on instructions received from a registered machine, the indicator of subjectivity and objectivity being a filter criterion.

16. A method as claimed in claim 4, wherein the reputation value is different for different categories and sub-categories, the reputation value being determined by the controller from ratings received for the comments received from a machine under a category.

17. A method as claimed in claim 14, wherein the controller displays comments for an initial period to collect ratings on the comments and, after the initial period, the controller determines a configurable value for each comment and uses the configurable value to determine if the comments should remain displayed; the initial period depending on at least one selected from the group consisting of: the category of the goods and services, the sub-category of the goods and services, whether the comment is from a registered machine or an unregistered machine, and the reputation value.

18. A method as claimed in claim 17, wherein the configurable value is determined by the controller from an average rating of the comments, and presentation of the comments.

19. A method as claimed in claim 18, wherein the controller folds all postings where the configurable value is below a threshold without displaying the comments on the web site.

20. A method as claimed in claim 19, wherein the controller displays on the web site at least one of: distribution of ratings of the folded comments, and a configurable percentile of the top rated comments.

21. A method as claimed in claim 17, wherein the controller posts comments without identifying the user who provided the comment when so instructed by the user's machine; performs archive folding on all comments that are older than a threshold of time irregardless of their ratings; and posts comments without performing archive folding when they are rated as “classic”.

22. A method to collaborate online to rank and review goods or services, the method comprising:
a machine sending to a controller rankings in accordance with defined criteria for each of the goods and services relative to others of the goods and services, the rankings being according to properties of the goods and services and categories and sub-categories of the goods and services; and
the machine sending to the controller comments on the goods and services.

23. A method as claimed in claim 22 further comprising amending an indicator of subjectivity and objectivity for each of the properties; and the machine sending to the controller proposals selected from the group consisting of: new goods, new services, new property for selected goods and services in a category, additional classifications for a particular product or service, to remove a classification for a particular product or service, to migrate a classification of a product or service, and to change a classification of selected goods or services, as well as objections to a ranking.

24. A method as claimed in claim 22, wherein the ranking of at least one of the goods and services differs according to the categories and sub-categories.

25. A method as claimed in claim 22 further comprising the machine sending to the controller comments according to at least one of: the categories and sub-categories; the comments being at least one selected from the group consisting of: on the goods and services, and on previous comments.
